(19) United States
(12) Patent Application Publication
(10) Pub. No.: US 2019/0358902 A1
(43) Pub. Date: Nov. 28, 2019

(54) MULTI-MATERIAL SEPARATION LAYERS FOR ADDITIVE FABRICATION

(71) Applicant: Formlabs, Inc., Somerville, MA (US)

(72) Inventors: Marcin Slaczka, Boston, MA (US); Benjamin FrantzDale, Harvard, MA (US); Ian Ferguson, Cambridge, MA (US)

(73) Assignee: Formlabs, Inc., Somerville, MA (US)

(21) Appl. No.: 16/404,524

(22) Filed: May 6, 2019

Related U.S. Application Data
(60) Provisional application No. 62/668,112, filed on May 7, 2018.

(51) Int. Cl. B29C 64/25; B29C 64/218; B29C 64/135; B29C 64/245

(52) U.S. Cl. CPC B29C 64/25; B29C 64/218; B33Y 80/00; B29C 64/245; B29C 64/135

(57) ABSTRACT

According to some aspects, a laminated multi-material separation layer is provided for use in an additive fabrication device wherein layers of solid material are formed in contact with the separation layer by curing a liquid photopolymer. In some embodiments, the laminated multi-material layer may include an elastic first layer that aids in separation of cured photopolymer from the container in addition to a barrier layer on an upper surface that protects the first layer from exposure to substances in the liquid photopolymer that may not be compatible with the material of the first layer.

### FIELD OF INVENTION

The present invention relates generally to systems and methods for separating a part from a surface during additive fabrication (e.g., 3-dimensional printing).

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as stereolithography, solid objects are created by successively forming thin layers of a curable polymer resin, typically first onto a substrate and then one on top of another. Exposure to actinic radiation cures a thin layer of liquid resin, which causes it to harden and adhere to previously cured layers or the bottom surface of the build platform.

### SUMMARY

According to some aspects, an additive fabrication device is provided configured to fabricate parts by curing a liquid photopolymer to form layers of cured photopolymer, the additive fabrication device comprising an open-topped vessel configured to hold the liquid photopolymer and comprising a laminated multi-material layer configured to facilitate separation of cured photopolymer from an exposed surface of the laminated multi-material layer, the laminated multi-material layer comprising a first material layer, and a barrier layer bonded to at least a portion of the first material layer, the barrier layer having an oxygen permeability of at least 10 Barrer and forming the exposed surface of the container, and at least one energy source configured to direct actinic radiation through the laminated multi-material layer and to cure the liquid photopolymer held by the vessel.

The foregoing embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. For purposes of clarity, not every component may be labeled in every drawing. In the drawings:

FIGS. 1A-1C illustrate a schematic view of a stereolithographic printer that forms a plurality of layers of a part, according to some embodiments;

FIG. 1D depicts an illustrative separation layer applied to the interior bottom surface of the container shown in FIGS. 1A-1C, according to some embodiments;

FIGS. 2A-B depict an illustrative additive fabrication device, according to some embodiments;

FIGS. 3A-3C illustrate a schematic view of a stereolithographic printer that forms a plurality of layers of a part on a separating layer acting as a suspended thin film, according to some embodiments; and

FIGS. 4A-4B and 5A-5C depicts various illustrative configurations of laminated multi-material separation layers, according to some embodiments.

### DETAILED DESCRIPTION

Systems and methods for separating a part from a surface during additive fabrication are provided. As discussed above, in additive fabrication a plurality of layers of material may be formed on a build platform. In some cases, one or more of the layers may be formed so as to be in contact with a surface other than another layer or the build platform. For example, stereolithographic techniques may form a layer of resin so as to be in contact with an additional surface such as a container in which liquid resin is located.

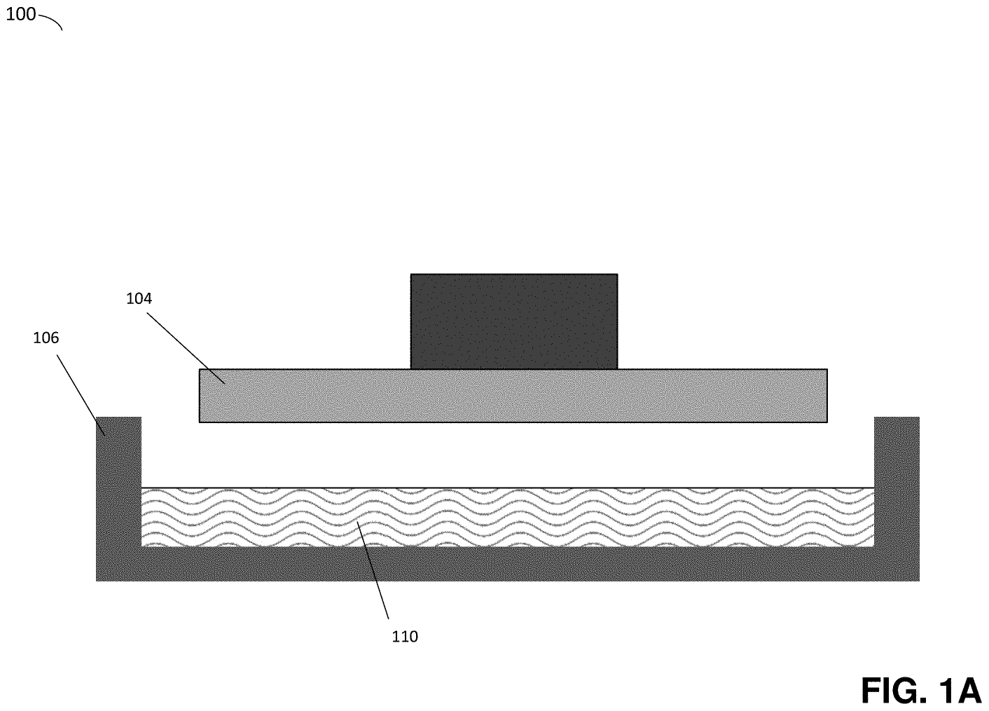

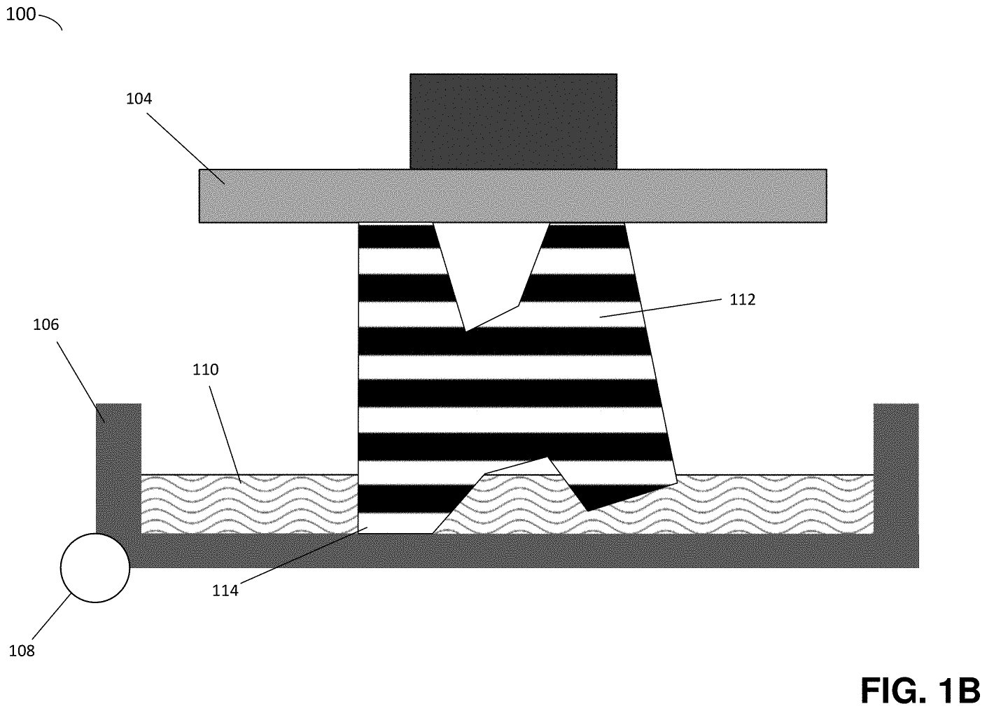

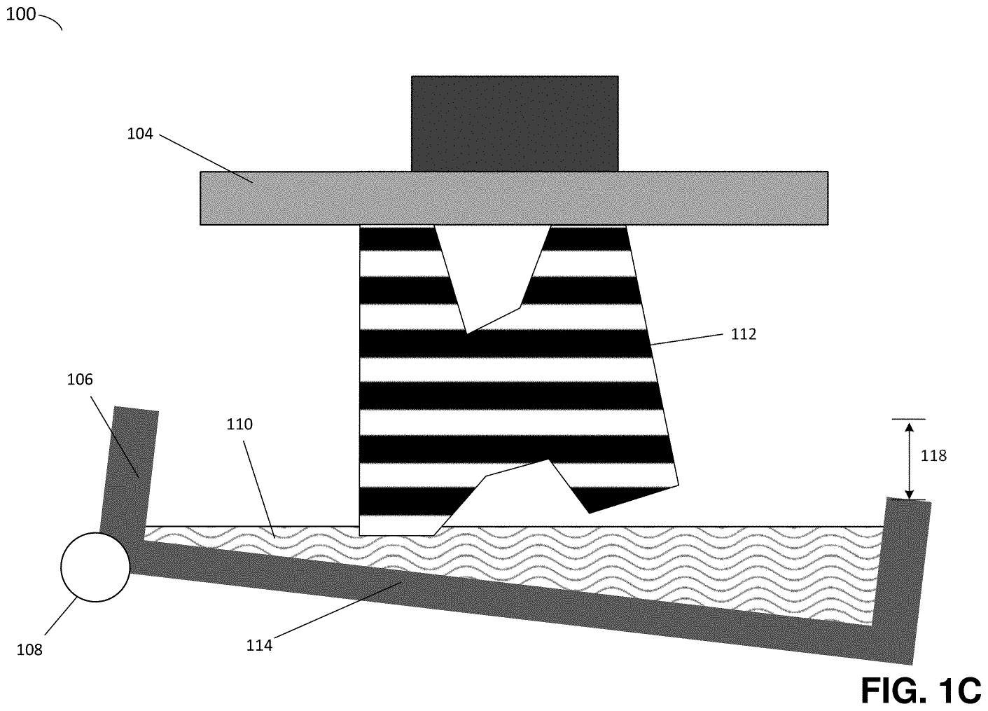

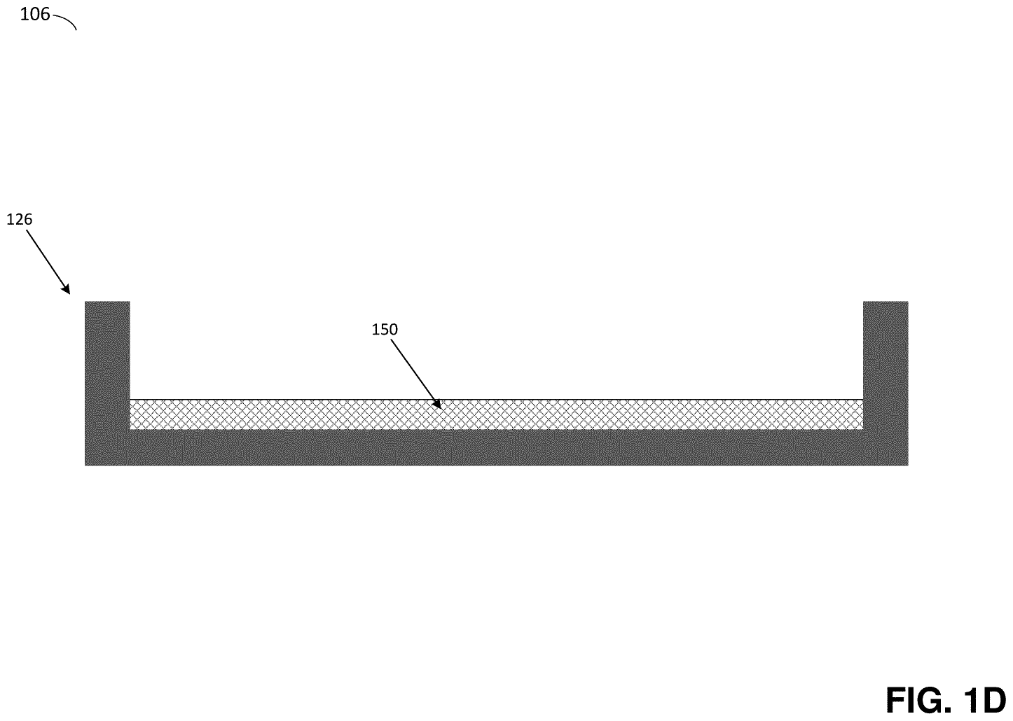

To illustrate one exemplary additive fabrication technique in which a part is formed in contact with a surface other than another layer or the build platform, an inverse stereolithographic printer is depicted in FIGS. 1A-C. Exemplary stereolithographic printer 100 forms a part in a downward facing direction on a build platform such that layers of the part are formed in contact with a surface of a container in addition to a previously cured layer or the build platform. In the example of FIGS. 1A-C, stereolithographic printer 100 comprises build platform 104, container 106, axis 108 and liquid resin 110. A downward facing build platform 104 opposes the floor of container 106, which is filled with a liquid photopolymer 110. FIG. 1A represents a configuration of stereolithographic printer 100 prior to formation of any layers of a part on build platform 104.

As shown in FIG. 1B, a part 112 may be formed layerwise, with the initial layer attached to the build platform 104. The container's floor may be transparent to actinic radiation, which can be targeted at portions of the thin layer of liquid photocurable resin resting on the floor of the container. Exposure to actinic radiation cures a thin layer of the liquid resin, which causes it to harden. The layer 114 is at least partially in contact with both a previously formed layer and the surface of the container 106 when it is formed. The top side of the cured resin layer typically bonds to either the bottom surface of the build platform 4 or with the previously cured resin layer in addition to the transparent floor of the container. In order to form additional layers of the part subsequent to the formation of layer 114, any bonding that occurs between the transparent floor of the container and the layer must be broken. For example, one or more portions of the surface (or the entire surface) of layer 114 may adhere to the container such that the adhesion must be removed prior to formation of a subsequent layer.

“Separation” of a part from a surface, as used herein, refers to the removal of adhesive forces connecting the part to the surface. It may therefore be appreciated that, as used herein, a part and a surface may be separated via the techniques described herein, though immediately subsequent to the separation may still be in contact with one another (e.g., at an edge and/or corner) so long as they are no longer adhered to one another.

Techniques for reducing the strength of the bond between a part and a surface may include inhibiting the curing process or providing a highly smooth surface on the inside of a container. In many use cases, however, at least some force must be applied to remove a cured resin layer from the container.

FIG. 1C depicts one illustrative approach in which a force may be applied to a part by rotating the container to mechanically separate the container from the part. In FIG. 1C, stereolithographic printer 100 separates part 112 from the container 106 by pivoting the container about a fixed axis 108 on one side of the container, thereby displacing an end of the container distal to the fixed axis a distance 118 (which may be any suitable distance). This step involves a rotation of the container 106 away from the part 112 to separate the most recently produced layer from the container, which may be followed by a rotation of the container back towards the part.

In some implementations, the build platform 104 may move away from the container to create a space for a new layer of liquid resin to form between the part and the container. The build platform may move in this fashion before, during and/or after the rotational motion of the container 106 described above. Irrespective of when the build platform moves, subsequent to the motion of the build platform a new layer of liquid resin is available for exposure and addition to the part being formed. Each step of the aforementioned curing and separating processes may continue until the part is fully created. By progressively separating the part and the container base, such as in the steps described above, the peak force and/or total force necessary to separate the part and container may be minimized.

Multiple problems may arise, however, due to the application of force during the above-described processes. In some use cases, the separation process may apply a force to and/or through the part itself. A force applied to the part may, in some use cases, cause the part to separate from the build platform, rather than the container, which may disrupt the fabrication process. In some use cases, a force applied to the part may cause deformation or mechanical failure of the part itself.

In some cases, forces applied to a part during separation processes can be reduced by forming the part in contact with an upper surface of a material with properties that assist in physical separation of the part from the material. A layer of this type of material is sometimes called a “separation layer.” Separation layers may be employed in a variety of additive fabrication devices, including but not limited to the inverse stereolithographic printer depicted in FIGS. 1A-C.

Suitable materials for forming a separation layer often exhibit elastic properties, which may reduce forces applied to the part by its contact with the container during separation. One illustrative material commonly used in the field in this manner is polydimethylsiloxane, also known as PDMS. Several types of PDMS, such as the PDMS formulation commercially available as Sylgard 184, have been used in order to provide an actinically transparent release layer on top of a more rigid substrate, such as described in U.S. patent application Ser. No. 14/734,141. PDMS is known to provide for a substantial degree of oxygen transmission, as well as for a substantial degree of actinic transparency. PDMS also provides substantial elasticity and mechanical properties understood to be favorable for separation layers. One disadvantage of PDMS, however, lies in its tendency to undergo undesirable reactions or alterations when exposed to certain substances. In this way, PDMS is said to be incompatible with these substances.

The incompatibility of PDMS and other elastic materials with certain substances may result in various undesirable changes to a separation layer when utilized with a photopolymer containing those incompatible substances, such as degradation of the mechanical or optical properties of the elastic material. For example, certain substances, such as isobornylacrylate, have been found to cause PDMS to expand, “swell” or even separate from other materials. This behavior may render a PDMS separation layer applied to the interior of a container in a stereolithographic printer unusable. As a result, certain substances of potential interest for use in photopolymers have not been considered suitable for use in stereolithographic resin containers that include a PDMS separation layer, despite the low cost and other advantages possessed by such a separation layer.

While there are other materials that could be used to form a separation layer in a container that are compatible with the above-mentioned substances of potential interest for use in photopolymers, those materials generally do not exhibit other desirable properties for use in additive fabrication. For example, the materials may be compatible but may not have desirable mechanical properties such as elasticity when used to facilitate separation of a part from a container whilst reducing forces applied to the part. In particular, oxygen permeability is a very desirable property for a separation layer since it appears that oxygen permeability of a material inhibits curing of at least some photopolymers. The production of a thin layer of uncured resin at the surface of the container due to curing inhibition aids in separation of cured resin from the container, since the layer reduces the adhesive forces between the newly formed layer of solid resin and the container. However, generally speaking highly oxygen permeable materials are not compatible with the above-mentioned substances of potential interest for use in photopolymers, and any that may be are prohibitively expensive.

The inventors have recognized and appreciated that a separation layer formed from laminated layers of different materials can provide the above-described advantages of elastic materials like PDMS whilst being compatible with substances of potential interest for use with photopolymers that are not compatible with the elastic materials themselves. As such, a laminated multi-material separation layer may exhibit desirable mechanical properties for separation of a part from the layer and sufficient oxygen permeability to inhibit curing of resin, whilst also being compatible with a wide array of substances. In general, embodiments of the present invention may advantageously utilize two or more materials in order to form a separation layer in such a way that advantages provided by any of the two or more materials are increased or obtained, while disadvantages typically associated with any of the two or more materials are reduced or minimized. A separation layer as described herein may be attached to an existing container and/or may form part of a container.

According to some embodiments, a first material, such as PDMS, is prevented from coming in contact with a photopolymer during normal operation of an additive fabrication device by a material placed to act as a “barrier layer” between the photopolymer and the first material. Forming solid material in contact with such a layer in a stereolithographic system may provide a combination of advantages, including desirable mechanical, optical, and chemical properties, efficiently and at potentially lower cost than other solutions. In some embodiments, one or more material layers may be combined with one or more barrier layers to form a laminated multi-material layer. Such a laminated multi-material layer may forms an interior bottom surface of a container used in an additive fabrication device (e.g., as container 106 in FIGS. 1A-1C), or may be used in some other device such that solid material is formed in contact with the layer.

In some cases, a laminated multi-material layer that includes a first material and a barrier layer may employ an impermeable material, such as fluorinated ethylene propylene (FEP) as the barrier layer. However, while FEP may provide a suitable barrier between the photopolymer and the first material, due to its impermeability it does not inhibit curing of resin at its surface which, as discussed above, is desirable because inhibition of curing can aid in separation of the container from a newly cured layer of solid photopolymer. As such, barrier layers with a higher oxygen permeability and/or oxygen selectivity than FEP are more desirable since one or both of those properties lead to inhibition of photopolymer curing, which in turn aids in separation.

According to some embodiments, a laminated multi-material separation layer may be substantially transparent to at least those wavelengths of actinic radiation used by the additive fabrication device in which the container is placed. For instance, an additive fabrication device that utilizes a laser beam with a wavelength of 405 nm to cure a photopolymer may utilize a laminated multi-material layer in which the multi-material layer include portions that are transparent to 405 nm light (although these portions may be transparent at other wavelengths as well). It should be noted that the one or more layers of the multi-material layer may include portions that are not so transparent so long as there is a transparent window through each of the components that allow light to be projected onto regions of a photopolymer held in the container.

Following below are more detailed descriptions of various concepts related to, and embodiments of, systems and methods for separating a part from a surface during additive fabrication. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

The techniques described herein may be generally applicable to numerous stereolithographic systems, and not just the illustrative systems shown in the figures. In some embodiments, structures fabricated via one or more additive fabrication techniques as described herein may be formed from, or may comprise, a plurality of layers. For example, layer-based additive fabrication techniques may fabricate an object by forming a series of layers, which may be detectable through observation of the object, and such layers may be any size, including any thickness between 10 microns and 500 microns. In some use cases, a layer-based additive fabrication technique may fabricate an object that includes layers of different thickness.

FIG. 1D depicts an illustrative separation layer 150 applied to the interior bottom surface of container 106 shown in FIGS. 1A-1C, according to some embodiments. In the example of FIG. 1D, the container 106 includes a body 126 and separation layer 150 applied to the interior of the container. In some embodiments, the separation layer 150 may be adhered or otherwise bonded to the frame 126 in a suitable way. Separation layer 150 may be a laminated multi-material separation layer as discussed above and of which further examples are described below. Container body 126 may comprise acrylic, glass, and/or any material of which at least part is actinically transparent. In some embodiments, the container body 126 is formed from a rigid material.

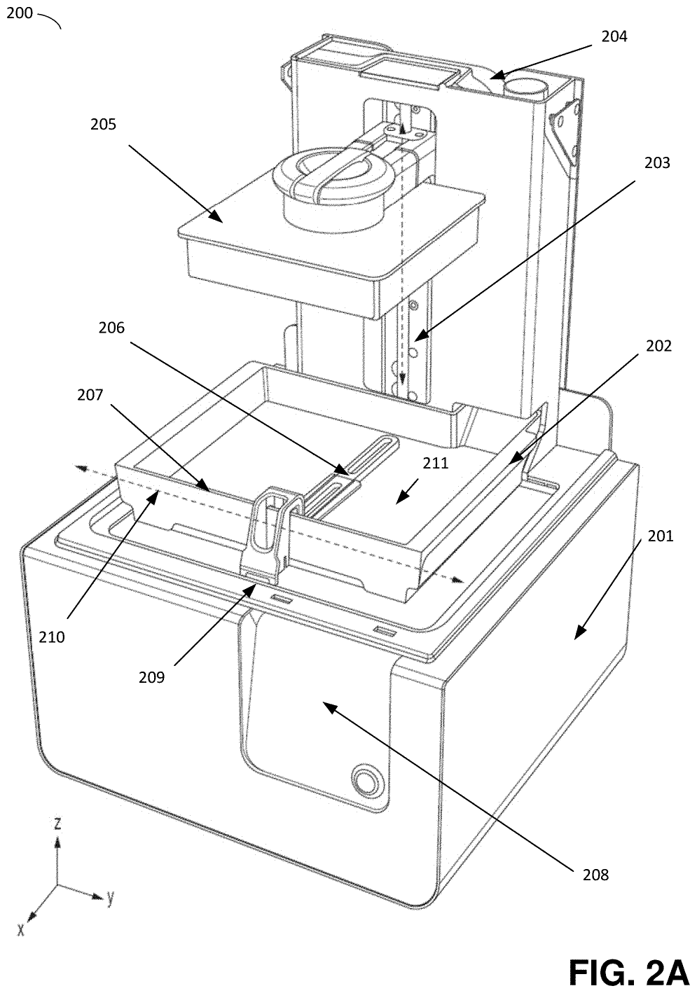

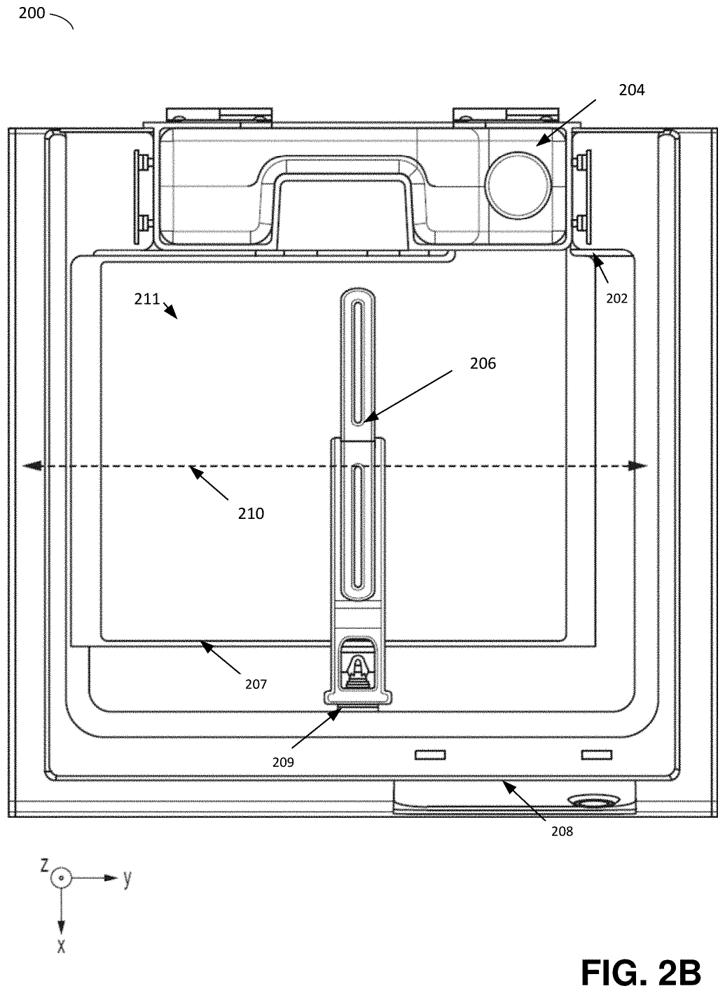

Another illustrative additive fabrication device in which a container having a laminated multi-material separation layer disposed therein may be utilized is shown in FIGS. 2A-B. For example, container 106 may be employed in system 200 of FIGS. 2A-2B. Illustrative stereolithographic printer 200 comprises a support base 201, a display and control panel 208, and a reservoir and dispensing system 204 for storage and dispensing of photopolymer resin. The support base 201 may contain various mechanical, optical, electrical, and electronic components that may be operable to fabricate objects using the system.

During operation, photopolymer resin may be dispensed from the dispensing system 204 into container 202. Container 202 may comprise a laminated multi-material separation layer, such as that within container 106 shown in FIG. 1D, for example.

Build platform 205 may be positioned along a vertical axis 203 (oriented along the z-axis direction as shown in FIGS. 2A-B) such that the bottom facing layer (lowest z-axis position) of an object being fabricated, or the bottom facing layer of build platform 205 itself, is a desired distance along the z-axis from the bottom 211 of container 202. The desired distance may be selected based on a desired thickness of a layer of solid material to be produced on the build platform or onto a previously formed layer of the object being fabricated.

In the example of FIGS. 2A-B, the bottom 211 of container 202 may be transparent to actinic radiation that is generated by a radiation source (not shown) located within the support base 201, such that liquid photopolymer resin located between the bottom 211 of container 202 and the bottom facing portion of build platform 205 or an object being fabricated thereon, may be exposed to the radiation. Upon exposure to such actinic radiation, the liquid photopolymer may undergo a chemical reaction, sometimes referred to as “curing,” that substantially solidifies and attaches the exposed resin to the bottom facing portion of build platform 205 or to an object being fabricated thereon. FIGS. 2A-B represent a configuration of stereolithographic printer 201 prior to formation of any layers of an object on build platform 205, and for clarity also omits any liquid photopolymer resin from being shown within the depicted container 202.

Following the curing of a layer of material, build platform 205 may be moved along the vertical axis of motion 203 in order to reposition the build platform 205 for the formation of a new layer and/or to impose separation forces upon any bond with the bottom 211 of container 202. In addition, container 202 is mounted onto the support base such that the stereolithographic printer 201 may move the container along horizontal axis of motion 210, the motion thereby advantageously introducing additional separation forces in at least some cases. A wiper 206 is additionally provided, capable of motion along edge 207 along the horizontal axis of motion 210 and which may be removably or otherwise mounted onto the support base at 209.

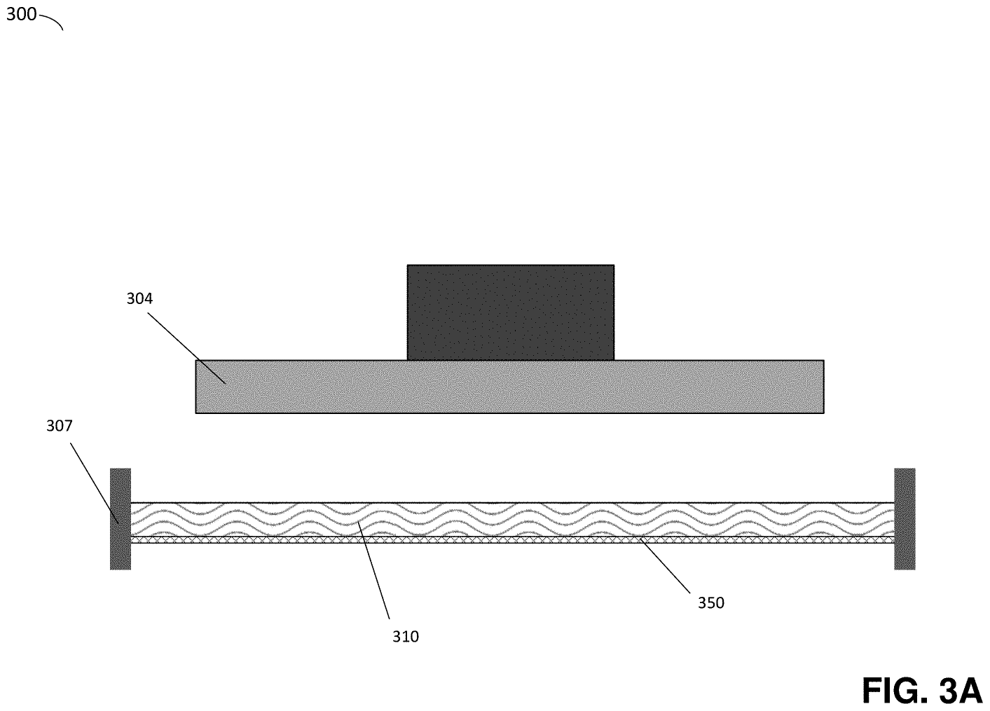

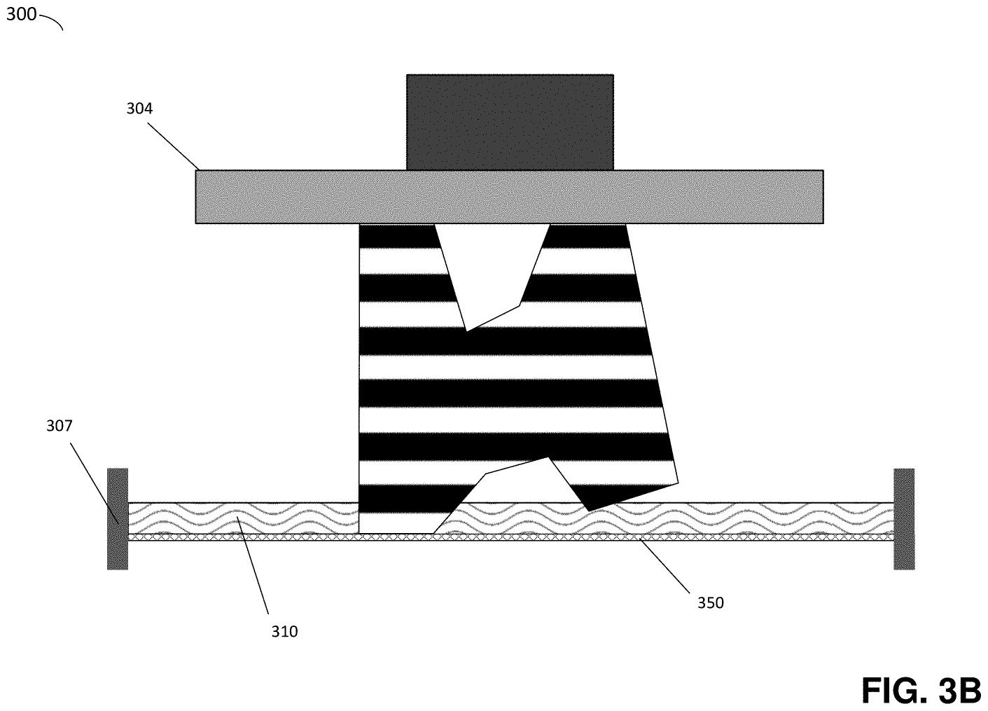

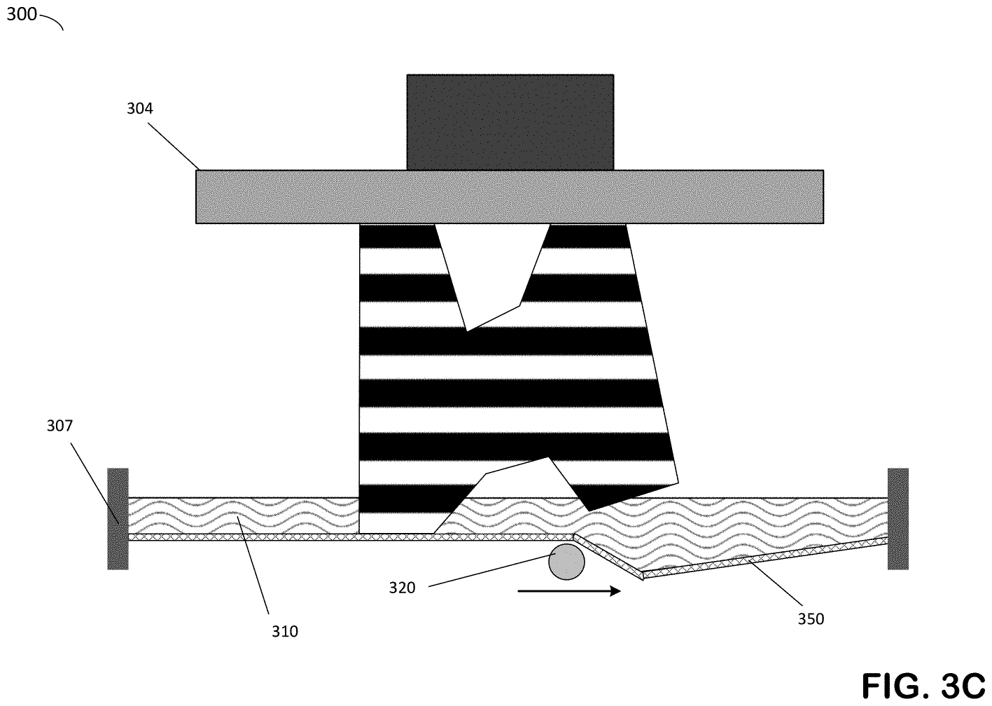

An additional stereolithographic device that may include a separation layer is illustrated in FIGS. 3A-3B. In the example of FIGS. 3A-3B, a liquid photopolymer 310 is held within a vessel that comprises supports 307 across which a thin film 350 is stretched. The film 350 may be tightened at least to a degree sufficient to hold the liquid within the vessel, and may in some cases be tightened enough to produce a flat surface on which layers of solid material may be formed by directing actinic radiation through the film into the liquid photopolymer. Stereolithographic device 300 includes a build platform 304.

In some embodiments, stereolithographic device 300 may include at least one roller 320, as shown in FIG. 3C, that moves across the underside of the film 350 and applies an upward force to the film to produce a flat surface on which solid material may be fabricated. In such cases, the film may not be completely taut and flat in the absence of the roller but may exhibit some level of “sag” (which may in some cases be very small). In some embodiments, when the roller moves away from an area of the film on which solid material has been fabricated, the weight of the film may cause partial or total peeling of the film away from the solid material.

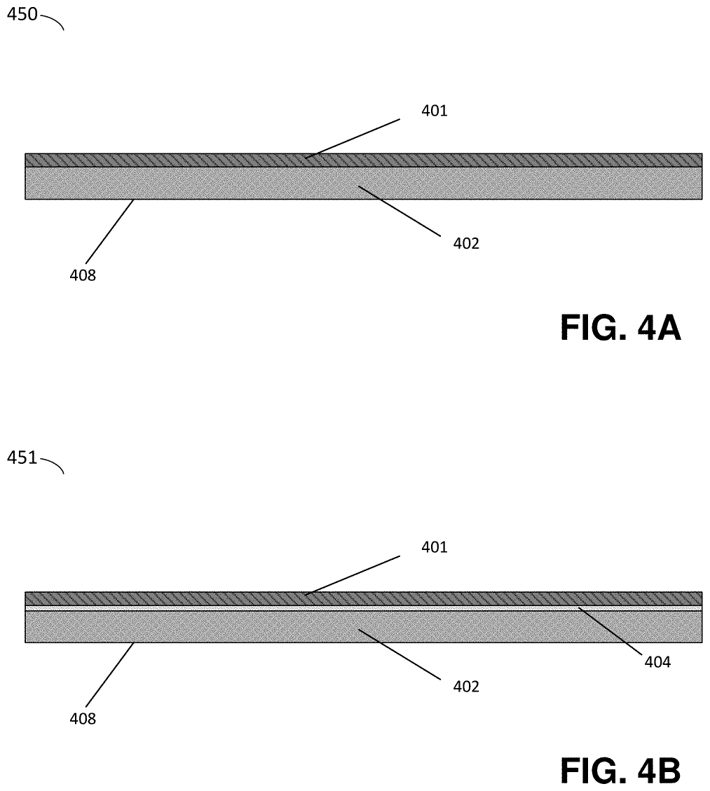

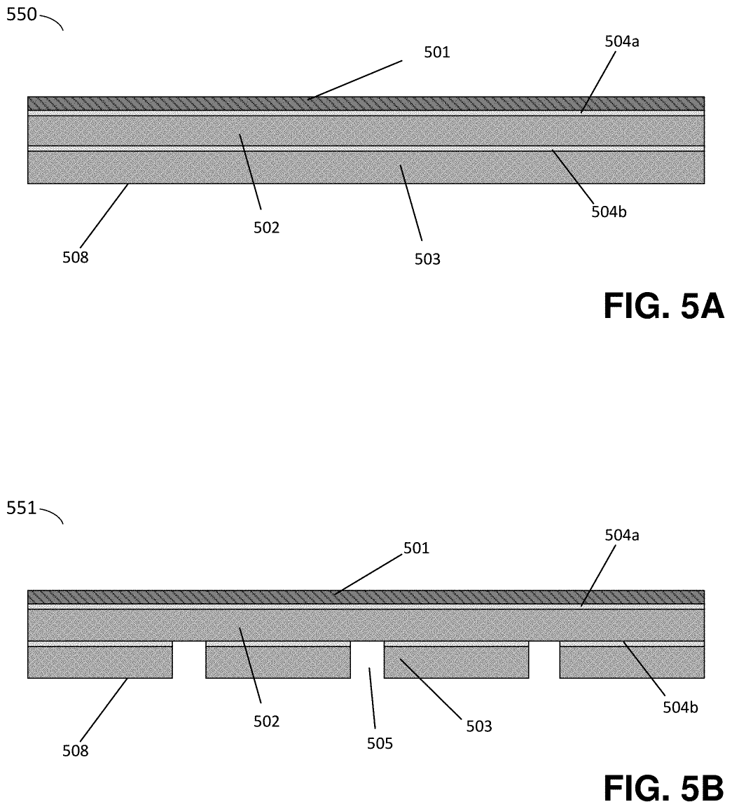

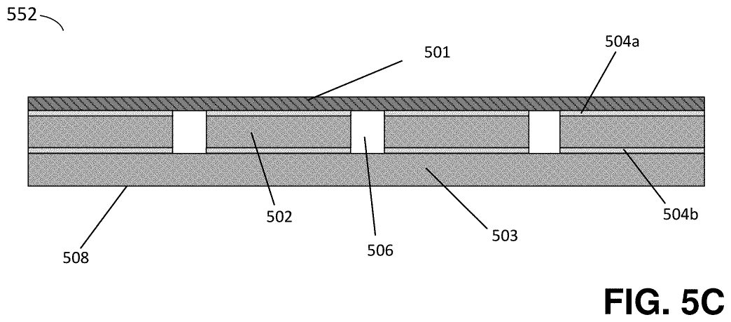

FIGS. 4A-4B and 5A-5C depict a number of different illustrative configurations of separation layers, any of which may be employed as separation layer 150 shown in FIG. 1D and/or separation layer 350 shown in FIGS. 3A-3C.

FIG. 4A depicts an illustrative laminated separation layer, according to some embodiments. In the example of FIG. 4A, separation layer 450 comprises a barrier layer 401 and a first layer 402. The first layer and barrier layer together comprise a laminated multi-material separation layer 450. A liquid photopolymer placed on the separation layer would contact the barrier layer 401 on its surface, but would not contact the first layer 402.

According to some embodiments, opposing surfaces of the first layer and the barrier layer may form an interface with one another. For example, surfaces of the first layer and the barrier layer may be bonded or otherwise adhered to one another. The surface 408 of the first layer 401 may be bonded or otherwise adhered to the surface of material forming the lower portion of a container (e.g., container 106), and/or to an optically transparent portion of the same. FIG. 4B depicts a separation layer 451 that includes barrier layer 401 and first layer 402 as shown in FIG. 4A, but also includes an adhesive layer 404 disposed between the barrier layer and first layer that acts to adhere the two layers together.

When in use (e.g., as separation layer 150 shown in FIG. 1D and/or separation layer 350 shown in FIGS. 3A-3C) the surface of the first layer 401 does not come into contact with a photopolymer, but instead is in contact only with the barrier layer 402 (and, in some embodiments, material forming the boundary of a container). As a result, it may not be necessary for the first layer 402 to be chemically compatible with each substance within the photopolymer. To the extent the barrier layer 401 is relatively impermeable to a given substance, the substance within the photopolymer will not be available at or within the first layer 402 for any unwanted interactions or reactions that might occur.

In some embodiments, the first layer 402 may be described as providing a mechanical substrate layer. In such embodiments, the mechanical substrate layer may be formed of a comparatively soft solid material with elastomeric properties while the barrier layer need only be sufficiently flexible so as not to restrict the motion of the substrate layer, whilst providing a barrier between the liquid photopolymer and the mechanical substrate layer.

In some embodiments, more than two materials may be selected in order to form the laminated separation layer. The multi-material separation layer may, for example, contain three, four or even more laminated layers. Additionally, or alternatively, one or more of the layers of the multi-material separation layer may contain an additive material that is present within the material of the layer. In some embodiments, a layer (e.g., a PMP layer) of a multi-material separation layer may incorporate materials such as talc or glass mineral fills. In general, while such additives may increase the opacity of the film material, the increase in opacity immediately proximate to the optical plane of exposure may result in only marginal decreases in accuracy or precision in the formation process. In some embodiments, the first layer and/or barrier layer may be a fiber-composite film such as disclosed in U.S. application Ser. No. 15/388,041, titled “Systems and Methods of Flexible Substrates for Additive Fabrication,” filed on Dec. 22, 2016, which is hereby incorporated by reference herein in its entirety.

FIGS. 5A-5C depict additional illustrative laminated separation layers, according to some embodiments. Each of depicted separation layers 550, 551 and 552 include a barrier layer and two additional layers that are bonded together with interleaved adhesive layers. Increasing the number of layers in a separation layer may increase the number of interfaces between materials with different indexes of refraction, and may thereby cause scattering, unwanted internal reflections, and/or other optical distortions. Moreover, the use of multiple layers within a film may substantially increase the tendency of the laminate film to wrinkle or otherwise deform under tension, such as described further below.

FIGS. 5A, 5B and 5C depict cross sections of illustrative separation layers 550, 551 and 552, respectively, according to some embodiments. As shown, each of these separation layers may comprise a barrier layer 501, located at an upper surface of the separation layer (that is, a surface arranged to come into contact with a liquid photopolymer when the separation layer is installed in a stereolithographic device). Each of the separation layers 550, 551 and 552 may also include a second layer 503, located at the lower boundary of the separation layer, and a first layer 502 interposed between the barrier and second film layers. Each separation layer 550, 551 and 552 may comprise interfacial adhesive layers 504a, 504b bonding layers of the separation layer. In particular, adhesive layer 504a bonds the barrier layer 501 to the first layer 502, and adhesive layer 504b bond the first layer 502 to the second layer 503. According to some embodiments, the surface 508 may be bonded or otherwise adhered to the surface of material forming the lower portion of a container (e.g., container 106), and/or to an optically transparent portion of the same.

In the example of FIGS. 5B and 5C, the separation layers 551 and 552 include layers that do not extend for the full width and/or breadth of the separation layer. As shown in FIG. 5B, for example, the second layer 503 may include gaps 505 at certain portions of the layer 503. Such gaps 505 may, among other advantages, potentially allow for greater transmission of a curing inhibitor, such as oxygen, through the composite film 500, particularly in embodiments wherein the second layer 503 is otherwise a limiting factor in permeability.

Alternatively, or additionally, as shown in FIG. 5C, gaps 506 may be formed within the first layer 502. Such gaps 506 may be distributed as discrete regions within a pattern of the second layer 502, such as a grid. In some embodiments, gaps 506 may be formed between linear “strips” of first layer 502. In such a configuration, gaps 506 may form channel-like structures suitable for the introduction of additional inhibitor material for transfer through the barrier layer 501, such as by introduction of air, oxygen gas, or carrier materials such as water or perfluorocarbons with dissolved oxygen. Such channels may be additionally advantageous to the extent that a flow of material through the channel-like gaps 506 may be established (e.g., when the separation layer 552 is arranged as a suspended thin film as in the example of FIGS. 3A-3C or otherwise). Material flow through the gaps 506 may enable the replenishment of inhibitory materials to the barrier layer, and/or may assist with thermal maintenance of the film and the adjacent photopolymer. Such thermal maintenance may include heating, so as to increase the temperature of the photopolymer resin adjacent to the barrier layer 501, but may also comprise cooling, such that excess heat generated by the photopolymerization process, which may be considerable, may be dissipated in order to better maintain the temperature of the unpolymerized photopolymer resin and prevent thermal damage to the composite film 500.

In some embodiments in which the separation layer 552 is arranged as a suspended thin film (e.g., as in the example of FIGS. 3A-3C or otherwise) gaps 506 may be ranged between linear strips of first layer 502 such that the linear strips are oriented along the major axis of tension for the separation layer 552 (i.e., the axis along which the tension is primarily applied).

In some embodiments, gaps 505 and/or gaps 506 in the examples of FIGS. 5B and 5C may, alternatively, be filled with one or more materials, rather than left as void-like spaces. For example, gaps 506 may be filled with a material with excellent permeability to an inhibitor, such as PDMS with permeability to oxygen, to provide transport through layer 502 that may otherwise lack such permeability. Alternatively, or in addition, a material may be chosen to fill gaps 506 in order to match indexes of refraction, such as described below in connection with adhesive materials.

The following paragraphs describe various embodiments and configurations of the separation layers depicted in FIGS. 4A, 4B, 5A, 5B and 5C. It will be appreciated that, in the following description, references to “a barrier layer,” or “the barrier layer,” may refer to any layer within a laminated separation layer that is arranged to contact a liquid photopolymer, including but not limited to the illustrative barrier layers 401 and 501. It will be further appreciated that, in the following description, references to “a first layer,” or “the first layer,” may refer to either or both of first layer 402 and first layer 502. Moreover, layers other than the barrier layer in the above-described separation layers may also be referred to collectively as “supporting layers.” For instance, the supporting layers in separation layer 450 include first layer 402; the supporting layers in separation layer 451 include first layer 402 and adhesive layer 404; and the supporting layers in separation layers 550, 551 and 552 include layers 502, 503, 504a and 504b.

In some embodiments, materials chosen to be relatively permeable to oxygen may demonstrate particular advantages over embodiments where either the first layer or the barrier layer lack such properties. As discussed above, oxygen may tend to inhibit photopolymerization reactions in certain photopolymer chemistries. This inhibition effect may result in a thin layer of uncured liquid photopolymer along the surface of a separation layer, potentially improving separation performance. As an example, separation layers formed from PDMS materials may have comparatively high oxygen permeability on the order of 500 Barrer.

In embodiments utilizing barrier layers having comparatively low oxygen permeability, such an inhibition layer on the surface of the separation layer may not be reliably formed. As discussed above, a barrier layer formed from an FEP material may provide certain advantages with respect to its chemical resiliency, but its low oxygen permeability (typically below 5 Barrer) reduces or eliminates any oxygen inhibition effect within a liquid photopolymer near the separation layer surface. On the other hand, materials possessing comparatively higher degrees of oxygen permeability, such as PDMS, may lack sufficient chemical resiliency or provide an inadequate barrier to photopolymer compounds. Accordingly, the selection of appropriate material(s) for the barrier layer may seek to balance chemical insensitivity of the first layer material and oxygen permeability and/or selectivity. Other factors may also influence such a decision, including cost, mechanical robustness, and manufacturability.

According to some embodiments, it may be advantageous to select material(s) for the barrier layer that have the greatest oxygen permeability that are also compatible with the compounds of the liquid photopolymer. In various experiments, the inventors have found PMP, such as described above, to possess superior chemical compatibility and resilience, while providing adequate oxygen permeability on the order of 35 Barrer. Other materials with Barrer values greater than 10-20 Barrer and acceptable compatibility, however, may be also be advantageous, examples of which have been discussed above. And, as may be appreciated by those having skill in the art, inhibition materials other than oxygen may be relevant for certain photopolymer chemistries. In such cases, the preceding observations regarding the permeability characteristic with respect to oxygen are applicable for the alternative inhibition material and its permeability through the selected material.

It may further be advantageous to select one or more materials in the barrier layer to be in contact with the liquid photopolymer such that the liquid photopolymer and the selected material(s) possess a high degree of wettability with respect to each other. In particular, it may be desirable for an additive fabrication device to be able to form thin films of liquid photopolymer having a consistent thickness against the surface of the material(s) for subsequent exposure to actinic radiation. Liquid photopolymer applied to a barrier layer material that possesses a low partial wetting may tend to form beads or otherwise tend to cohere rather than to spread readily across the surface of the material into a substantially uniform thin layer. As such, FEP, Teflon AF, and other such “non-stick” surfaces, which typically comprise surfaces with low surface energies, provide poorly wetted surfaces with regards to liquid photopolymer. While this low surface energy may be advantageous for the separation of cured photopolymer, it is undesirable with regards to the formation of thin films of liquid photopolymer. The inventors have determined that PMP, in contrast, is substantially more wettable with respect to a wide range of liquid photopolymers than FEP, such that thin films of photopolymer may more reliably be formed against a first material formed of PMP, despite the fact that PMP possesses excellent separability with respect to cured photopolymer. For instance, a layer of PMP, such as sold under the TPX or PMP-MX brands, of approximately 0.005″ may provide for an effective barrier layer for use with a wide range of photopolymer resins.

Laminated multi-material separation layers as described herein provide a number of additional advantages over conventional separation layers, such as the use of PDMS alone. As one example, separation layers formed of PDMS alone have a well-known tendency to degrade in a way known as “clouding” or “fogging.” Without wishing to be limited to a specific theory, the inventors postulate that this form of degradation may be substantially due to the diffusion and/or absorption of photopolymer substances into the PDMS material and subsequent chemical reactions within the PDMS material. The relative impermeability of a barrier layer material, such as PMP, however, dramatically increases the effective working lifetime of photopolymer containers as described herein. This is believed to be due, in part, to the substantially reduced migration of photopolymer substances through the barrier layer material into the bulk of the separation layer. This reduction in migration and/or reduction in separation layer degradation processes further advantageously allows for substantial increases in the effective resolution and accuracy of parts formed using embodiments of the present invention. This is believed to be due in part to improved consistency in the transmission of actinic radiation through the separation layer resulting from reduced migration of photopolymer substances into the separation layer and subsequent degradation processes. In addition, the inventors have observed significantly less scattering of actinic radiation transiting through a laminated multi-material separation layer.

In some embodiments, materials from which a barrier layer is formed may include, may consist substantially of, or may consist of polymethylpentene, also known as PMP. PMP may, for example, be available from Mitsui Chemicals America, Inc. under the TPX brand. The inventors have recognized that PMP materials possess several advantageous properties with respect to stereolithographic applications, including very low surface tension (less than 50 mN/m) allowing for lower separation forces, high degrees of transparency to actinic radiation, low refractive index, high gas (particularly oxygen) permeability, and excellent resistance of a broad variety of substances potentially of interest for use in liquid photopolymers.

According to some embodiments, the barrier layer 401 may have a thickness that is between 0.001″ and 0.010″, between 0.005″ and 0.025″, between 0.0025″ and 0.0075″, between 0.002″ and 0.006″, or between 0.003″ and 0.005″. In some embodiments, the barrier layer is a thin film. For example, the barrier layer may be a thin film of PMP having a thickness that is between 0.003″ and 0.005″.

As discussed above, since oxygen permeability inhibits curing of a photopolymer, it may be preferable to select one or more materials of the barrier layer to have sufficient oxygen permeability to effect such inhibition of curing. Moreover, to make the multi-material layer compatible with a wide range of photopolymer substances, a barrier layer may be selected that is relatively impermeable to desirable substances within a photopolymer (which in at least some cases may also be incompatible with the material of a supporting layer). The inventors have recognized several suitable materials that exhibit these desirable properties. Hence, according to some embodiments, the barrier layer may comprise: PMP, a fluorosilicone, fluorosilicone acrylate, polymethylpentene, poly(1-trimethylsilyl-1-propyne), polytetrafluoroethylene-based or amorphous fluoroplastics, PTFE or similar materials branded Teflon or Teflon AF by Dupont, polyethylene terephthalate (PET), polyethylene terephthalate glycol-modified (PETG), or combinations thereof.

According to some embodiments, one or more materials of supporting layers may be selected with reduced concern for the chemical compatibility of the material(s) with substances in a liquid photopolymer that will come into contact with the separation layer. In some embodiments, material(s) of one or more supporting layers in a laminated separating layer may (e.g., layer 402, layer 502 and/or layer 503) comprise polydimethylsiloxane (PDMS). For example, a PDMS material commercially available as Sylgard 184 from Dow Corning combined with Sylgard 527, also available from Dow Corning, mixed together at a 3:1 ratio has been used as a material of a supporting layer.

In some embodiments, multiple forms of PDMS may be combined together in order to form a supporting layer of a multi-material separation layer. As one example, Sylgard 184 may be combined with Sylgard 527 in a three to one ratio and formed into a supporting layer as described above. As another example, bonds formed between a first layer and a barrier layer, or between a first layer with surfaces of a container, may be enhanced in strength by the application of a third material substantially located between the first layer and barrier layer and/or between the first layer and the surfaces of the container. In this way, potentially incompatible materials which may not otherwise adhere together strongly or at all may be successfully utilized.

In some embodiments, a supporting layer (e.g., layer 402, layer 502 and/or layer 503) may have an oxygen permeability of greater than or equal to 100 Barrer, 150 Barrer, 200 Barrer, 250 Barrer or 300 Barrer. In some embodiments, the supporting layer may have an oxygen permeability of less than or equal to 800 Barrer, 750 Barrer, 600 Barrer or 400 Barrer. Any suitable combinations of the above-referenced ranges are also possible (e.g., an oxygen permeability of greater or equal to 300 Barrer and less than or equal to 600 Barrer, etc.). Preferably, the supporting layer may have an oxygen permeability that is in the range 100 Barrer to 800 Barrer, or in the range 250 Barrer to 750 Barrer, or in the range 300 Barrer to 600 Barrer, or in the range 400 Barrer to 600 Barrer. In use cases in which multiple supporting layers are arranged within a separating layer, the different supporting layers may have the same, or different, oxygen permeabilities.

In some embodiments, a barrier layer may have an oxygen permeability of greater than or equal to 5 Barrer, 10 Barrer, 15 Barrer, 20 Barrer or 25 Barrer. In some embodiments, the barrier layer may have an oxygen permeability of less than or equal to 100 Barrer, 80 Barrer, 60 Barrer, 40 Barrer or 35 Barrer. Any suitable combinations of the above-referenced ranges are also possible (e.g., an oxygen permeability of greater or equal to 10 Barrer and less than or equal to 40 Barrer, etc.). Preferably, the barrier layer may have an oxygen permeability that is in the range 10 Barrer to 100 Barrer, or in the range 15 Barrer to 60 Barrer, or in the range 10 Barrer to 40 Barrer, or in the range 20 Barrer to 35 Barrer.

To the extent that a given material is more permeable to a first compound than to a second compound, the material is said to have a “selectivity” for the first compound versus the second compound. Such selectivity may be expressed in terms of a ratio between the measurement of permeability for the first compound over the second compound wherein the ratio is greater than 1.0. To use the above examples, since FEP is relatively equally impermeable to all compounds, the selectivity of a given material versus a different material for FEP will likely be close to 1. In contrast, PMP may have a selectivity for oxygen versus photopolymer compounds that is greater (or much greater) than 1.

It may further be advantageous that the barrier layer has a substantial degree of selectivity for oxygen, or an alternative inhibition material, over that of compounds in the photopolymer. In particular, materials such as PMP polymer films may form membranes with a desired permeability to different compounds. The degree of permeability of such a membrane may depend at least in part upon the particular compound permeating the material. With regards to materials that are relatively impermeable, variation due to molecular size of the compound may be the dominant factor with regard to any limited permeability.

For more permeable materials, however, that permeability may vary based in part on other chemical properties of a compound. According to some embodiments, a separation layer may comprise a permeable material that has a higher selectivity for oxygen, or another relevant cure inhibitor, than for compounds in the photopolymer resin,. Such a separation layer may advantageously allow for inhibiting compounds (e.g., oxygen) to diffuse into the photopolymer while preventing compounds in the photopolymer resin from permeating into or through the separation layer. For example, a barrier layer may have a high selectivity for oxygen versus one or more compounds of the photopolymer. Such a selectivity may be between 1 and 10, or between 2 and 20, or at least 5, or at least 10, or at least 20, or at least 50.

According to some embodiments, by forming a separation layer from a permeable material with selectivity for oxygen, or another relevant cure inhibitor, over compounds in the photopolymer resin, the laminate separation layer may advantageously allow for inhibiting compounds to diffuse into the photopolymer resin while preventing compounds in the photopolymer resin from permeating into or through the separation layer. This permeability may be particularly important for a barrier layer, as it is in contact with a photopolymer. The permeability of supporting layers, however, may also be important, as impermeable supporting layers may restrict the amount of inhibitor, such as oxygen, available for transport through a supporting layer. In some embodiments, this may addressed by selecting materials for all such layers with a comparatively high degree of inhibitor permeability.

In some embodiments, one or more of the layers in a laminated separating layer may be formed from coatings which alone may not have sufficient mechanical strength or cohesiveness to maintain integrity independently. Such coatings may be applied onto a substrate which provides the cohesion and integrity to the coating layer. As one example, the barrier layer 501 shown in FIGS. 5A-5C may be a coating layer deposited or formed onto the first layer 502 as a substrate. Such a barrier layer may comprise, for instance, a highly oxygen-permeable material such as Teflon AF 1600 or 2400, available from The Chemours Company, deposited with a thickness of between 2 and 10 microns onto the first layer 502.

In some embodiments in which a supporting layer comprises PET, since PET may be comparatively impermeable to oxygen or other gases, it may be advantageous to form gaps within the PET film (e.g., gaps 505 and/or gaps 506) to allow for oxygen, or other inhibitory materials, to diffuse into and through the PET film and into the barrier layer. For example, the first layer 502 may comprise a film of polyethylene terephthalate (PET) material, which may be readily hard-coated with various materials, such as Teflon AF 2400, to form a barrier layer 501. A hard coating may function to protect the film and prevent scratching, and may be comprised of any coating able to protect the film from damage or scratching over time, such as but not limited to an acrylic- or urethane-based coating.

In some embodiments utilizing such hard coating barrier layers, it may be advantageous for gaps within one or more supporting layers to have sufficiently small diameters or cross sectional areas that regions of the barrier layer located above such gaps retain adequate support to “bridge” or otherwise extend across the gap. As one example, holes of approximately 1-15 microns may be formed in a PET film of between 25 and 100 micron thickness in order to form gaps (e.g., gaps 505 and/or gaps 506) in a grid pattern across the PET film with row and column spacings of 1-10 mm. Alternatively, suitable grid patterns may be determined based upon the desired amount of permeability by approximating the diffusion of gases through gaps 506 modelled using conventional approaches for calculating diffusion through perforated membranes, including as described in [https://aip.scitation.org/doi/abs/10.1063/1.338127] and [https://www.sciencedirect.com/science/article/pii/S0376738802003034]. In some embodiments, such holes may be formed by puncture with a needle or other stylus, but may more rapidly and accurately formed by using a laser drilling process. In some embodiments, such as those formed using laser drilling techniques, gaps 506 may not be perfect cylinders through the PET film, but instead form a truncated conic section with one or more taper angles, such as taper angles of between 5 and 7 degrees. Following the formation of the holes in the film, a thin coating of material, such as Teflon AF 2400, may then be applied as a coating over the PET film.

In some embodiments, Teflon AF may be applied suspended in a bulk solvent via spin, spray, brush, or dipping techniques. Due to the “non-stick” nature of many suitable materials, including Teflon AF, it may be advantageous to further treat PET film prior to deposition to increase adhesive forces, including the use of coronal/plasma treatments and/or by heating the PET substrate above the glass transition temperature (Tg) of the substrate. In some embodiments, a suitable Tg may be between 67 and 80 C, depending upon the amount of crystallinity of the PET material chosen. Following coating, the bulk solvent transporting the Teflon AF material may be partially or totally removed or extracted in order to leave a smooth coating of Teflon AF material and further improve adherence. Such removal may be accomplished in various ways, including via the use of increased temperatures, reduced pressure, and/or various other techniques. In some cases, multiple applications of coating material may be advantageous to help ensure that a continuous, smooth surface is formed by bridging any gaps formed in the supporting film. Alternatively, or additionally, such coating material may fill some or all of such holes, thus forming material-filled gaps allowing for transit of material through the PET film. The PET film may be secured during processing steps via vacuum table or other suitable jig during such processing. In some use cases, an additional supporting layer may be formed by the application of a coating material onto a first supporting layer as a substrate, such as by adding a coating to form layer 503 on layer 502.

In some embodiments, the inventors have found it advantageous to select adhesive materials to form adhesive layers 504a and/or 504b such that the index of refraction of the adhesive materials is as close as possible to the adhered layers or, if different, as close as possible to the index of one of the two materials or the geometric mean of the index of the two materials. In some embodiments, a layer of approximately 0.001″ of thickness of pressure sensitive adhesive, such as 3M 8211 Optically Clear adhesive may be applied between film layers 501 and 502 and/or between film layers 502 and 503. In some embodiments, other bonding techniques may be utilized in alternative or addition to liquid transparent adhesives, such as thermal or ultrasonic bonding.

In addition to the structural material layers described above, in some embodiments additional functional elements may be incorporated into laminated separating layer between layers of material and/or within gaps present within supporting layers. As one example, indicating marks, or fiducials, may be printed, deposited, or otherwise laminated into the separating layer. In some cases, such indicating marks may be located along the sides or corners of the separating layer. One type of indicating mark may be scattering or absorbing material, such as disclosed in U.S. patent application Ser. No. 15/865,421, titled “Optical Sensing Techniques for Calibration of an Additive Fabrication Device and Related Systems and Methods,” filed on Jan. 9, 2018. In some embodiments, the fiducial mark may be registered and fixed in location within the plane of the film by the composite film structure itself for calibration purposes.

In some embodiments, an additive fabrication device may be configured to determine the extent to which a separating layer has deformed or undergone creep by sensing fiducial marks within the separating layer. For instance, in cases in which the separating layer has tension applied to it (e.g., as in the example of FIGS. 3A-3C), the device may sense fiducial marks within the separating layer to measure deformation of the layer due to tension forces applied against the layer. In some embodiments, however, such fiducial marks may be placed on the upper or lower surface of the separating layer, rather than between layers. One example of such an application is the use of fiducial marks placed onto the bottom surface of a separating layer arranged as a suspended thin film in an additive fabrication device wherein a device (e.g., one or more rollers) moves repeatedly while contacting the separating layer. In such a device, the marks may be gradually worn away over time by said motion, and by sending the presence of the marks the wear state of the separating layer may be determined.

In some embodiments, fiducial marks may convey additional information regarding a separating layer and/or a tank mounting the separating layer, such as providing 1D or 2D barcodes, company logos, and/or usage information or instructions printed either onto or between the layers of the laminated separating layer.

In some embodiments, a separating layer may include one or more light filtering layers. As one example, a band pass filter or cutoff filter may be incorporated into the separating layer such that one or more specific frequencies of actinic radiation may be transmitted through the film, while other frequencies, such as visible light, may be blocked from transmission. Further, various active devices may be incorporated into such a separating layer. As one example, resistive heating traces may be embedded into the separating layer, using thin, flexible circuitry. As another example, various sensors, such as deflection, stress, strain, temperature, induction (e.g., for resin-level), RFID, or light sensors, may be similarly incorporated between layers of the laminated separating layer. Likewise, the separating layer could include imaging components such as flexible LCD or OLED displays.

In some embodiments in which a separating layer is arranged as a suspended thin film (e.g., as in the example of FIGS. 3A-3C), a supporting layer may be selected from various materials with comparatively high degrees of tensile strength and/or resistance to creep or other deformation when placed under tension. Such tensile strength may be particularly valuable in applications utilizing thin films as separation layers, wherein the thin film is placed under tension during operation, as described above.

In some embodiments in which a separating layer is arranged as a suspended thin film (e.g., as in the example of FIGS. 3A-3C), one or more supporting layers may be flexible, but comparatively inelastic compared with the barrier layer (e.g., a thin material with both a comparatively high yield strain and Young's modulus). One example of a suitable material is a film, approximately 0.002″ thick, of an optically clear polystyrene.

In some embodiments in which a separating layer is arranged as a suspended thin film (e.g., as in the example of FIGS. 3A-3C), a supporting layer arranged furthest from the barrier layer may be in periodic contact with various mechanical devices, such as roller elements, which may contact the supporting layer and/or exert forces against it while in motion. Accordingly, the supporting layer material may be advantageously selected from materials with suitable mechanical properties for such repeated contact, such that a lower wear may be achieved. In certain embodiments, such properties may also include superior resistance to abrasion and puncture, comparatively low friction and/or a comparatively high degree of lubricity. In may further be advantageous to select a material with substantial elasticity, such that the supporting layer may be resistant to punctures or other failure modes where excess force is applied to the separating layer.

In some embodiments, the barrier layer may comprise an aliphatic thermoplastic polyurethane (TPU) to provide substantial resistance to both wear and potential puncture forces. Such a layer may have a thickness of between 0.001″ and 0.005″, or approximately 0.002″. The barrier layer may then be adhered or otherwise bonded onto a supporting layer (e.g., first layer 402 or first layer 502) using an adhesive layer or otherwise. As those having skill in the art will appreciate, such film layer bonding may be accomplished in various means, including the use of corona treatments to overcome low surface energies and various forms of adhesive.

In some embodiments in which a separating layer is applied to the interior surface of a liquid photopolymer container (e.g., as in the example of FIGS. 1A-1D), one or more supporting layers may comprise, or may be comprised of, a cast layer of material (e.g., PDMS) poured into the bottom of a container to a depth of approximately 1-10 mm, and cured into an elastic solid. In some embodiments, supporting layers may be formed from materials other than PDMS, including materials heretofore not considered for use in separation layers due to chemical incompatibility with common liquid photopolymer materials. Various elastomeric materials with the requisite transparency to actinic radiation may thus be made suitable for use in such a separation layer. As one example, various forms of thermoplastic polyurethane (TPU) may be selected to provide acceptable degrees of elasticity and transparency. According to some embodiments, advantageous materials for the first layer may have a durometer value according to Shore Type A measurements of between approximately 10 and 50, with a range of 20-30 being the most successful.

In some embodiments in which a separating layer is applied to the interior surface of a liquid photopolymer tank (e.g., as in the example of FIGS. 1A-1D), the separation layer may be formed in the following steps: first, approximately 120 ml of uncured PDMS material, such as Sylgard 184, may be introduced into a transparent acrylic container with a bottom dimension of 217 mm by 171 mm and the PDMS material allowed to cure; subsequently, 20-25 ml of additional uncured PDMS material may be introduced into the container on top of the previously cured PDMS material; a thin film of PMP film of the same size as the PDMS area may then be placed on top of the PDMS layer such that uncured PDMS is spread across the area of the PMP film and the previously cured PDMS material; and a flat applicator may be utilized in order to ensure the flush application of the PMP film to a level surface of PDMS material and the curing process completed, forming a bond between the PMP film and the PDMS and a bond between the PDMS and the acrylic container. In other instances, a container including a multi-material separation layer may be manufactured using other techniques, such as casting a barrier material onto a first material in subsequent depositions, spin coating a barrier material onto a first material, vapor or plasma deposition of a barrier material onto a first material, and/or other methods that may be suitable for the selected first and barrier materials.

In some embodiments, one or more layers may be further selected to provide a “reservoir” source of oxygen or other cure inhibitors, such that the reservoir layer is capable of at least temporarily maintaining a quantity of cure inhibitor in a dissolved, suspended, or other captured state. In a first period, cure inhibitor may be consumed or otherwise utilized at a rate exceeding the rate of replenishment, reducing the amount of cure inhibitor captured within a reservoir layer. During a second period, however, cure inhibitor may be consumed or otherwise utilized at a lower rate, below the rate of replenishment, such that the amount of cure inhibitor captured within the reservoir layer may increase up to the maximum capacity of the reservoir layer. The inventors have observed that the length of first periods of comparative depletion are typically much shorter than the length of second periods of comparative replenishment. Accordingly, the use of one or more layers as reservoir sources may allow for the use of less permeable materials, providing lower replenishment rates, while avoiding completing depletion of the reservoir layer. In some cases, reservoir layers may be provided by use of voids or other physical gaps. In other embodiments, one or more materials may be selected in order to optimize the maximum capacity of the material. In many cases, the inventors have found that the maximum capacity of the material is closely related to the permeability of the material. In other embodiments, the maximum capacity of the reservoir layer may be optimized by increasing the thickness or amount of the reservoir material, thus increasing the total capacity for materials with a capacity per unit volume.

Reference is made herein to materials being “transparent.” It will be appreciated that transparency of a container and transparency of a multi-material separation layer disposed thereon is relevant insomuch as actinic radiation is to be transmitted to a photopolymer within the container. As such, “transparency” refers to transparency to actinic radiation, which may, or may not, mean transparency to all visible light. In some embodiments, actinic radiation may comprise radiation in the visible spectrum—accordingly, a material transparent to such actinic radiation will be transparent to at least one wavelength of visible light.

Moreover, elements exhibiting various degrees of gas permeability, particularly oxygen permeability are discussed herein. The permeability values provided above may be the result of any suitable testing protocol for gas permeability, including the differential pressure method (including, but not limited to, the vacuum method) and the equal pressure method. For example, the permeability value provided above may be the result of the ISO 15105 standardized testing protocol for measuring the gas permeability of materials.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An additive fabrication device configured to fabricate parts by curing a liquid photopolymer to form layers of cured photopolymer, the additive fabrication device comprising:
an open-topped vessel configured to hold the liquid photopolymer and comprising a laminated multi-material layer configured to facilitate separation of cured photopolymer from an exposed surface of the laminated multi-material layer, the laminated multi-material layer comprising:
a first material layer; and
a barrier layer bonded to at least a portion of the first material layer, the barrier layer having an oxygen permeability of at least 10 Barrer and forming the exposed surface of the container; and
at least one energy source configured to direct actinic radiation through the laminated multi-material layer and to cure the liquid photopolymer held by the vessel.

2. The additive fabrication device of claim 1, wherein the laminated multi-material layer is bonded to an interior bottom surface of the vessel.

3. The additive fabrication device of claim 1, wherein the laminated multi-material layer is suspended between at least two supports.

4. The additive fabrication device of claim 3, further comprising at least one roller configured to contact portions of the laminated multi-material layer.

5. The additive fabrication device of claim 1, wherein the barrier layer comprises polymethylpentene (PMP).

6. The additive fabrication device of claim 1, wherein the barrier layer has a higher selectivity for oxygen than for any compound of the liquid photopolymer.

7. The additive fabrication device of claim 1, wherein the first material layer comprises polydimethylsiloxane (PDMS).

8. The additive fabrication device of claim 1, wherein the first material layer has an oxygen permeability of at least 200 Barrer.

9. The additive fabrication device of claim 1, wherein the second material layer has an oxygen permeability between 20 Barrer and 50 Barrer.

10. The additive fabrication device of claim 1, further comprising a second material layer, the second material layer arranged between the first material layer and the barrier layer.

11. The additive fabrication device of claim 1, wherein the first material layer is bonded to the barrier layer with a pressure-sensitive adhesive.

12. The additive fabrication device of claim 1, wherein the barrier layer has a thickness between 1 mm and 10 mm.

13. The additive fabrication device of claim 1, wherein the first material layer has a thickness between 0.001″ and 0.01″.

14. The additive fabrication device of claim 1, wherein the first material layer is a fiber composite film.

15. The additive fabrication device of claim 1, wherein the barrier layer and the first material layer are transparent to the actinic radiation.
